(19) United States
(12) Patent Application Publication
(10) Pub. No.: US 2025/0209505 A1
(43) Pub. Date: Jun. 26, 2025

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventors: Hiromu YAMAWAKI, Tokyo (JP); Takahiro ISHIKAWA, Tokyo (JP); Junichi SATO, Tokyo (JP)

(21) Appl. No.: 18/945,315

(22) Filed: Nov. 12, 2024

(30) Foreign Application Priority Data
Dec. 20, 2023 (JP) 2023-215277

(51) Int. Cl. G06Q 30/04; G06F 40/40

(52) U.S. Cl. CPC G06Q 30/04; G06F 40/40

(57) ABSTRACT

An information processing device according to the present application includes a selection unit, a generation unit, and a providing unit. The selection unit selects a prompt corresponding to a request of a user from among a plurality of prompts whose details are kept secret from the user. The generation unit inputs information containing the prompt selected by the selection unit into generative AI, and causes the generative AI to generate information corresponding to the prompt selected by the selection unit. The providing unit provides, to the user as provided information, the information generated by the generation unit or information based on the generated information.

### CROSS-REFERENCE TO RELATED APPLICATION

The present application claims priority to and incorporates by reference the entire contents of Japanese Patent Application No. 2023-215277 filed in Japan on Dec. 20, 2023.

### BACKGROUND OF THE INVENTION

### 1. Field of the Invention

The present invention relates to an information processing device, an information processing method, and a non-transitory computer readable storage medium.

### 2. Description of the Related Art

In recent years, there are technologies known to generate information using Generative artificial intelligence (AI). For example, Japanese Patent No. 7313757 discloses a technology that uses large language models (LLM), which is a technology that generates a prompt in which effective sentences are added as additional sentences to an input question sentence within a defined character limit. A prompt is information input to the generative AI, which is information indicating an instruction, a request, and the like given to the generative AI for causing the generative AI to execute a specific task, for example.

However, since additional sentences are automatically added with the conventional technology described above, there is room for further improvement in terms of supporting the use of more appropriate prompts corresponding to the requests of the users.

### SUMMARY OF THE INVENTION

An information processing device according to the present application includes a selection unit, a generation unit, and a providing unit. The selection unit selects a prompt corresponding to a request of a user from among a plurality of prompts whose details are kept secret from the user. The generation unit inputs information containing the prompt selected by the selection unit into generative AI, and causes the generative AI to generate information corresponding to the prompt selected by the selection unit. The providing unit provides, to the user as provided information, the information generated by the generation unit or information based on the generated information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing information processing according to an embodiment;

FIG. 2 is a diagram illustrating an example of the configuration of an information processing system according to the embodiment;

FIG. 3 is a diagram illustrating an example of the configuration of an information processing device according to the embodiment;

FIG. 4 is a diagram illustrating an example of a user information table stored in a user information storage unit of the information processing device according to the embodiment;

FIG. 5 is a diagram illustrating an example of a secret prompt table stored in a secret prompt storage unit of the information processing device according to the embodiment;

FIG. 6 is a flowchart illustrating an example of information processing performed by a processing unit of the information processing device according to the embodiment; and

FIG. 7 is a hardware configuration diagram illustrating an example of a computer that implements functional features of the information processing device according to the embodiment.

### DETAILED DESCRIPTION OF THE PREFERRED EMBODIMENTS

Hereinafter, modes (referred to as “embodiments” hereinafter) for embodying an information processing device, an information processing method, and a non-transitory computer readable storage medium according to the present application will be described in detail with reference to the accompanied drawings. Note that the information processing device, the information processing method, and the non-transitory computer readable storage medium according to present application are not limited by the embodiments. In each of the following embodiments, same reference signs are applied to the same components, and redundant explanations are avoided.

### 1. Example of Information Processing

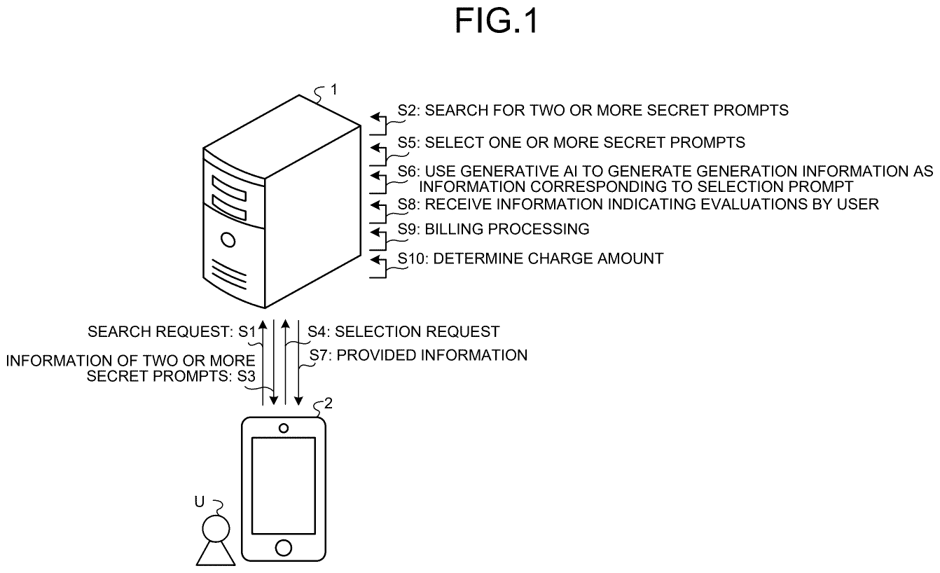

First, an example of information processing according to an embodiment will be described by referring to FIG. 1. FIG. 1 is a diagram for describing the information processing according to the present embodiment.

An information processing device 1 illustrated in FIG. 1 is an information processing device that works with each terminal device 2 of a user U and provides various kinds of information online to the user U. For example, it is implemented by one or more servers, a cloud system, or the like. The terminal device 2 is a smartphone, a tablet, a personal computer, or the like, for example.

As illustrated in FIG. 1, the information processing device 1 receives a search request from the user U (step S1). For example, the information processing device 1 receives a search request from the user U by receiving the search request transmitted from the terminal device 2 of the user U.

The search request contains user-related information that includes user setting information, which is the information set by the user U, and user information, which is the information about the user U who is to be the user of a secret prompt to be described later. The user U to be the user of the secret prompt is not limited to the user U of the terminal device 2 that has sent the search request, and may be any user U other than the user U of the terminal device 2 that has sent the search request. This allows the user U of the terminal device 2 to provide the secret prompt for other users U.

The user setting information is, for example, information of a character string “prompt enabling . . . ”, information of a character string “prompt for doing . . . ”, or the like. Note that “ . . . ” is a character string indicating the operation, processing, or the like that the user U desires for generative artificial intelligence (AI) to do.

For example, the user setting information may be information of a character string “prompt for summarizing the latest information on OOO”, information of a character string “prompt enabling proofreading of sentences”, information of a character string “prompt functioning as a shopping assistant”, and the like. Note that “OOO” is a specific target (for example, a person). The user setting information is not limited to the examples described above. For example, the user setting information may be information of a character string that describes the content of the operation, processing, and the like desired by the user U in more details.

The user information includes identification information of the user U. The identification information of the user U is, for example, but not limited to, the identifier (ID) of the user U or a cookie of the browser of the terminal device 2.

The generative AI is, for example, a text-generative AI, an image-generative AI, or a multimodal generative AI. The text generative AI is, for example, a large language model trained to infer and output the next token from an input sequence of tokens. Examples thereof may be a transformer-based model or a recurrent neural network (RNN)-based model, and a mixture of those models may also be used. The text-generative AI may also be a composite system combined with an identification machine and the like for preventing unauthorized use.

The transformer-based models are, for example, but not limited to, Generative Pre-trained Transformer (GPT) (registered trademark), Pathways Language Model Version 2 (PaLM2), and the like. The RNN-based models are, for example, but not limited to, Receptance Weighted Key Value (RWKV), and the like.

The image-generative AI is AI that generates images from texts. Examples thereof are, but not limited to, Generative Adversarial Networks (StackGAN), AttnGAN, Text-to-Image (T2I) with Transformers, Diffusion models, and the like. Examples of the Diffusion models may be DALL-E, Stable-Diffusion, and the like.

The multimodal generative AI is, for example, generative AI that generates at least one of text, image, and audio from at least one of text, image, and audio. The multimodal generative AI is, for example, but not limited to, GPT-4 Turbo with vision, gemini, Chameleon Multimodal Model (CM3Leon), and the like.

Note that it is desirable for the generative AI to be trained such that the generated results do not contain personal information and the like. The generative AI is installed in an external information processing device, and the information processing device 1 uses the generative AI via an application programming interface (API). The generative AI may also be installed within the information processing device 1.

Subsequently, the information processing device 1 searches for two or more secret prompts corresponding to the search request from among a plurality of secret prompts (step S2). Each of the secret prompts is a prompt whose details are kept secret from the user U, and the user U is not able to grasp the detailed content of the secret prompt. Each of the secret prompts is, for example, a prompt provided by a prompt provider that is a business operator or administrator different from the provider of the generative AI described above. Note that the secret prompt may be a prompt that is provided by the user U as a prompt provider.

The secret prompt contains, for example, but not limited to, part of or all of the information of character strings indicating a definition of a task to be executed by the generative AI, a constraint condition of a task to be performed by the generative AI, a definition of the behavior and tone of the generative AI, an output format of the generative AI, and the like.

For example, when the generative AI is GPT by OpenAI (registered trademark), the secret prompt contains information of the character strings included in the input information that is input to the generative AI in association with the information indicating the role. The role is the system, user, or the like. The secret prompt is a prompt that contains at least one out of a system message whose role is system and a user message whose role is a user.

The system message is a prompt indicating the role of the generative AI, for example, and a user message is a prompt indicating a message of the user as the role, for example. The system message includes information of character strings indicating a definition of a task to be executed by the generative AI, a constraint condition of a task to be performed by the generative AI, a definition of the behavior and tone of the generative AI, an output format of the generative AI, action examples of the generative AI, and the like, for example. However, the system message is not limited thereto, and may include part of such information.

The system message may also be a message indicating a scenario, for example. In that case, for example, the system message may further contain information of a character string indicating a task end condition in the generative AI described above.

The user message may include information of character strings indicating a definition of a task to be executed by the generative AI, a constraint condition of a task to be performed by the generative AI, a definition of the behavior and tone of the generative AI, an output format of the generative AI, action examples of the generative AI, and the like, and it may also be a message that includes part of such information.

Furthermore, when the generative AI is GPT of OpenAI, the secret prompt may further include an assistant message whose role is an assistant. The assistant message is an output message by the generative AI or a message that is treated as an output message.

At step S2, the information processing device 1 includes a secret prompt database that contains a plurality of secret prompts, and specifies a secret prompt corresponding to a search request by searching and acquiring the secret prompt corresponding to the search request from such secret prompt database.

The secret prompt database contains, for each secret prompt, information of the secret prompt including, for example, identification information of the secret prompt, title of the secret prompt, heading information of the secret prompt, vector information of the heading information of the secret prompt, information indicating the secret prompt, and the like. Such a secret prompt database contains secret prompts in accordance with search queries in a searchable manner.

The heading information of a secret prompt is information that indicates a description for describing functional features of the secret prompt (for example, an overview of the functional features, and the like), and vectorization of the heading information of the secret prompt is performed by embedding using a sentence embedding model (for example, a transformer-based model), for example. The vector information of the heading information of the secret prompt is represented by, for example, but not limited to, vectors of hundreds of dimensions.

Embedding using a sentence embedding model is, for example, but not limited to, embedding using text-embedding-ada provided by OpenAI, Bidirectional Encoder Representations from Transformers (BERT), and the like.

Note that vectorization of the heading information of the secret prompt is not limited to embedding using the sentence embedding model. For example, vectorization of the secret prompt may be performed using Doc2Vec, the average of word embedding, and the like. For example, Word2Vec, fastText, and the like are used for word embedding.

The information processing device 1 vectorizes the user setting information included in a search request by the same method used when vectorizing the heading information of the secret prompt. Then, the information processing device 1 acquires the secret prompts corresponding to the heading information whose similarity of vectors with the user setting information is equal to or higher than a threshold or the top m-pieces (m is 2 or higher) of secret prompts corresponding to the heading information in descending order of the similarity from the secret prompt database as a search result.

Instead of the vector information of the heading information of the secret prompts, the secret prompt database may contain information of each of a plurality of keywords included in the secret prompts or the heading information thereof. In this case, for example, the information processing device 1 acquires the secret prompt that contains one or more terms included in the user setting information in the search request or the secret prompt corresponding to the heading information from the secret prompt database as a search result.

Furthermore, instead of or in addition to the vector information of the heading information of the prompts, the prompt database may also contain the vector information of the prompts. In this case, the information processing device 1 acquires the prompts whose similarity of vectors with the user setting information is equal to or higher than a threshold or the top m-pieces (m is 2 or higher) of prompts in descending order of the similarity from the prompt database as prompt candidates.

The secret prompt database may also contain information indicating the charge amount for the secret prompts, information indicating the number of selections of the secret prompts, information indicating evaluations of the secret prompts, and the like. The charge amount for the secret prompt is the fee paid by the user U for the use of the secret prompt.

Subsequently, the information processing device 1 provides the user U with information of two or more secret prompts acquired by the search performed at step S2 by transmitting the information of two or more secret prompts acquired by the search performed at step S2 to the terminal device 2 (step S3).

The terminal device 2 displays the information of two or more secret prompts transmitted from the information processing device 1. The information of the secret prompts displayed on the terminal device 2 contains the titles of the secret prompts and the heading information of the secret prompts. The user U checks the titles and heading information of the two or more secret prompts, and operates the terminal device 2 to select one or more secret prompts from the two or more secret prompts displayed on the terminal device 2.

The information of the secret prompts displayed on the terminal device 2 may also contain information indicating the charge amount for the secret prompts, information indicating the number of selections of the secret prompts, information indicating evaluations of the secret prompts, and the like. In this case, the user U can select one or more secret prompts from the two or more secret prompts displayed on the terminal device 2 by checking the information indicating the charge amount for the secret prompts, the information indicating the number of selections of the secret prompts, the information indicating evaluations of the secret prompts, and the like.

When the user U designates one or more secret prompts from the two or more secret prompts searched by the information processing device 1, the terminal device 2 transmits a selection request containing information for identifying the one or more secret prompts designated by the user U to the information processing device 1 (step S4).

Furthermore, when additional information as supplemental information is required for using the secret prompt designated by the user U, the user U inputs the additional information by operating the terminal device 2. The additional information is an additional prompt when the generative AI is a text-generative AI, and it is at least one of an additional prompt and additional image data when the generative AI is a multimodal generative AI.

For example, when the secret prompt designated by the user U is a prompt that requires additional information, the user U can input the additional information into the terminal device 2 by operating the terminal device 2. Thereby, a selection request including information specifying one or more secret prompts designated by the user U and the additional information is transmitted from the terminal device 2 to the information processing device 1.

A prompt that requires additional information is, for example, information of a character string “You are an experienced travel planner. You propose a three-day travel plan for a specific request from a user. The plan includes places to visit, accommodations, places to eat, and activities.” In this case, the additional information is, for example, information of a character string “Please create a travel plan for Okinawa. My interests are history and cuisine. Budget is 200,000 yen per person.”

Also, a prompt that requires additional information is, for example, information of a character string “You are a good proofreader. You detect up to 20 errors in the input text and suggest corrections. The output format includes incorrect sentences, correct sentences, and descriptions of the errors.” In this case, the additional information is information of the character string to be the target of proofreading.

Upon receiving a selection request transmitted from the terminal device 2, the information processing device 1 selects one or more secret prompts that are specified by the selection request from among a plurality of secret prompts (step S5). One or more secret prompts selected by the information processing device 1 are associated with the user U of the terminal device 2 that has sent the selection request.

Then, the information processing device 1 inputs the information including the selection prompt that is the secret prompt selected at step S5 to the generative AI, and causes the generative AI to generate generation information that is the information corresponding to the selection prompt (step S6).

For example, it is assumed that the selection prompt is a prompt that does not require additional information. In this case, the information processing device 1 inputs the information including the selection prompt to the generative AI, and causes the generative AI to generate the generation information that is the information corresponding to the selection prompt.

The selection prompt that does not require additional information is, for example, a prompt that gives an instruction to collect information on a specific target (for example, a specific disaster, a specific person, a specific object) whose status changes and to generate current information and summary information on the specific target.

In this case, for example, the information processing device 1 collects, according to the selection prompt, information on a specific target (for example, a specific disaster, a specific person, a specific object) whose status changes, inputs, as input information, information containing the collected information and instruction information indicating an instruction to execute specific processing for the collected information, and causes the generative AI to generate the generation information that is the information corresponding to the selection prompt. The specific processing includes, for example, but not limited to, processing for organizing the collected information in a specific format, processing for summarizing the collected information, and the like.

The selection prompt that does not require additional information is, for example, a prompt that contains information of a character string that gives an instruction to perform specific processing that repeats processing for outputting a character string according to a condition determined in advance or repeats processing for outputting an image according to a condition determined in advance.

Furthermore, it is assumed that the selection prompt is a prompt that requires additional information. In this case, the information processing device 1 inputs the information containing information that includes the selection prompt and additional information included in the selection request to the generative AI, and causes the generative AI to generate the generation information that is the information corresponding to the selection prompt and the additional information.

A selection prompt that requires additional information is, for example, a prompt that gives an instruction to execute a specific task for the additional information. A specific task may be, for example, but not limited to, summarizing additional information, analyzing additional information (for example, sentiment analysis or the like), translating additional information, improving or proofreading additional information, generating an article or a story about additional information, and the like.

A selection prompt that requires additional information may also be a prompt for executing a specific task with the user U in a chat format, for example. In this case, the specific task is a task to perform Question and Answer (Q&A) on a specific category (for example, economy, education, or the like) in a chat format, which is a task that has the user U input information indicating a question sentence as additional information and causes the generative AI to generate information indicating an answer sentence for the question sentence.

A specific task may also be a task that has the user U sequentially input the necessary information for the user U to create information on a specific target (for example, various application forms, a novel, a cooking recipe, a blog, or the like) as additional information, and causes the generative AI to generate the information on the specific target based on such additional information.

The secret prompt selected as the selection prompt may be a prompt that includes intention definition information for extracting the intention type and the intention content. Intention definition information includes, for example, instruction information containing an instruction to extract the intention type and the intention content from the user input information, and definition information containing the information that defines the intention type and the intention content. When using API provided by OpenAI, for example, the information processing device 1 can cause the generative AI to generate intention information by using the functional feature of function calling.

The intention type is, for example, the type of intention of the additional information, and the information indicating the intention type is, for example, information specifying the function or the functional feature corresponding to the intention type. Furthermore, the intention content is the content of intention of the additional information, and the information indicating the intention content is, for example, information indicating the function argument or the parameter of the functional feature corresponding to the intention type.

In this case, intention information containing the information indicating the intention type and the information indicating the intention content is generated by the generative AI. The information processing device 1 can cause the generative AI to generate the generation information by acquiring information from an external information processing device, an internal storage unit, or the like using the intention information generated by the generative AI and inputting, to the generative AI, information containing the acquired information and instruction information indicating an instruction to generate the generation information using the acquired information.

Furthermore, when the selection prompt includes a message indicating a scenario, the information processing device 1 can repeat the processing for acquiring output by inputting information into the generative AI according to the scenario until the task end condition is satisfied, and generate the generation information based on the result of such processing. In this case, the information processing device 1 includes, in the input information to be input to the generative AI, an input/output record that contains information that is input to the generative AI in the past and information that is output by the generative AI in the past during execution of the tasks.

For example, the information processing device 1 can cause the generative AI to generate generation information by inputting the information containing the input/output record to the generative AI as the input information while changing the content to be generated by the generative AI according to the scenario, until the task end condition is satisfied.

The information input into the generative AI according to the scenario is information collected from the external information processing device, the internal storage unit, or the like, or additional information input by the user U. For example, the information processing device 1 collects information from the external information processing device, the internal storage unit, or the like according to the scenario until the task end condition is satisfied, and causes the generative AI to generate the generation information based on the collected information.

The information processing device 1 can also have the user U input the additional information according to the scenario until the task end condition is satisfied, and cause the generative AI to generate the generation information based on such additional information.

When a plurality of secret prompts are selected at step S5, the information processing device 1 causes the generative AI to generate the generation information for each of the selected secret prompts. This allows the information processing device 1 to acquire the generation information for each of the selection prompts.

Subsequently, the information processing device 1 provides the generation information generated at step S6 or information based on the generation information to the user U as provided information (step S7). The information processing device 1 provides the generation information generated at step S6 or information based on the generation information to the user U as provided information by transmitting the generation information generated at step S6 or the information based on the generation information to the terminal device 2 as the provided information. This makes it possible to provide the user U with, as the provided information, the generation information generated by using the secret prompt while concealing the detailed content of the secret prompt or the information based on the generation information.

When the information generated as the generation information using the generative AI is the intention information, the information processing device 1 can use such intention information to acquire information from the external information processing device, the internal storage unit, or the like, and generate the provided information based on the acquired information.

Furthermore, when the generation information for each of the selection prompts is generated using the generative AI, the information processing device 1 provides the user U with the provided information for each of the selection prompts. In this case, the terminal device 2 displays the provided information for each of the selection prompts, and the user U can compare the provided information for each of the selection prompts.

Subsequently, the information processing device 1 receives information indicating the evaluations of the provided information made by the user U (step S8). The user U can check the provided information displayed on the terminal device 2, operate the terminal device 2, and input the information indicating the evaluations of the provided information.

The evaluation of the provided information is on a scale of 10, for example, but may also be on a scale of 9 or lower, or a scale of 11 or higher. The information indicating the evaluation may also be information of character strings such as reviews or comments.

Subsequently, the information processing device 1 performs billing processing for the user U to whom the provided information is provided at step S7 (step S9). The billing processing is, for example, the processing of payment by the user U for the charge amount linked to the secret prompt that is used to generate the provided information provided to the user U at step S7.

The information processing device 1 can, for example, perform billing processing by transmitting billing information that includes information indicating the charge amount and information specifying the user U to a device of a financial institution, or by transmitting billing information that includes information indicating the charge amount and information specifying the credit card number of the user U to a device of a credit card company.

The user U can also pay the fee for the secret prompt with points instead of or in addition to a specific currency. For example, the information processing device 1 can also perform the billing processing by transmitting billing information that includes information indicating the number of points corresponding to the charge amount and information specifying the user U to a device of a point management company.

Note that points are, for example, but not limited to, rewards given to the user U by a point management company or the like, when the user U makes purchases with credit cards or cash, or when the user U subscribes to specific services.

Subsequently, the information processing device 1 determines the charge amount for the use of the secret prompt (step S10). For example, the information processing device 1 determines the charge amount based on the evaluations of the provided information made by each of the users U. The information processing device 1 determines a higher charge amount for the secret prompt with a higher average value of the evaluations of the provided information made by each of the users U.

The information processing device 1 can determine the charge amount based on the evaluations of the provided information made by each of the users U on the basis of a reference amount set by the provider of the secret prompt. For example, the information processing device 1 determines the charge amount to be lower than the reference amount for the secret prompt whose average value of the evaluations of the provided information made by each of the users U is lower than a reference value. The reference value is 5 when the evaluation is on a scale of 10.

The information processing device 1 can also determine the charge amount based on the number of uses of the secret prompt by the user U. For example, the information processing device 1 determines a higher charge amount for the secret prompt with a larger number of the uses by the user U.

The information processing device 1 can also determine the charge amount based on the evaluations of the provided information made by each of the users U and the number of uses of the secret prompt used by the user U. For example, the information processing device 1 determines a higher charge amount for the secret prompt with a higher score that is acquired by applying weighted addition on the average value of the evaluations of the provided information made by each of the users U and the number of uses of the secret prompt used by the user U.

The information processing device 1 can also receive a tentative selection request transmitted from the terminal device 2. The tentative selection request contains information indicating two or more secret prompts designated by the user U as the selection candidates. Upon receiving the tentative selection request, the information processing device 1 selects two or more secret prompts indicated in the tentative selection request as two or more selection prompt candidates.

Furthermore, when additional information as supplemental information is required for using the selection prompt candidates, the tentative selection request contains additional information for each of the selection prompt candidates in addition to the specification information that is information indicating two or more selection prompt candidates.

The information processing device 1 then inputs the information including the selection prompt candidates to the generative AI, and causes the generative AI to generate, for each of the selection prompt candidates, candidate generation information that is the information corresponding to the selection prompt candidates. The generation method of the candidate generation information is the same as the generation method of the generation information described above.

The information processing device 1 provides the information for selection to the user U by transmitting, to the terminal device 2, the information for selection containing each piece of the generated candidate generation information or information based on each piece of such candidate generation information. The information for selection contains, for each of the selection prompt candidates, the candidate generation information or the information based on the candidate generation information while being associated with the information of the selection prompt candidate (for example, information indicating the title of the selection prompt candidate or heading information). The candidate generation information as well as the information based on the candidate generation information is the same information as the provided information described above. However, such information may also be part of the provided information, and may also be written as candidate provided information in the following.

Upon receiving the information for selection transmitted from the information processing device 1, the terminal device 2 displays such information for selection. This allows the user U to compare the candidate provided information among two or more selection prompt candidates by checking the candidate provided information generated using each of the two or more selection prompt candidates, and to designate and use a more appropriate secret prompt as the selection prompt.

The user U checks the candidate provided information corresponding to each of the selection prompt candidates included in the information for selection displayed on the terminal device 2, and designates one or more selection prompt candidates by operating the terminal device 2. In this case, as in the case of the processing performed at step S4, the terminal device 2 transmits a selection request containing information for specifying one or more selection prompt candidates designated by the user U to the information processing device 1.

As described, the information processing device 1 selects a prompt corresponding to the request from the user U from among a plurality of prompts whose details are kept secret from the user U, inputs the information containing the selection prompt that is the selected prompt to the generative AI, and causes the generative AI to generate information corresponding to the selection prompt. The information processing device 1 then provides the information generated by the generative AI or the information based on such generated information to the user U as the provided information. This allows the information processing device 1 to generate information using a more appropriate prompt corresponding to the request of the user U.

Hereinafter, the configuration and the like of an information processing system including the information processing device 1 and the terminal device 2 performing such processing will be described in detail below.

### 2. Configuration of Information Processing System

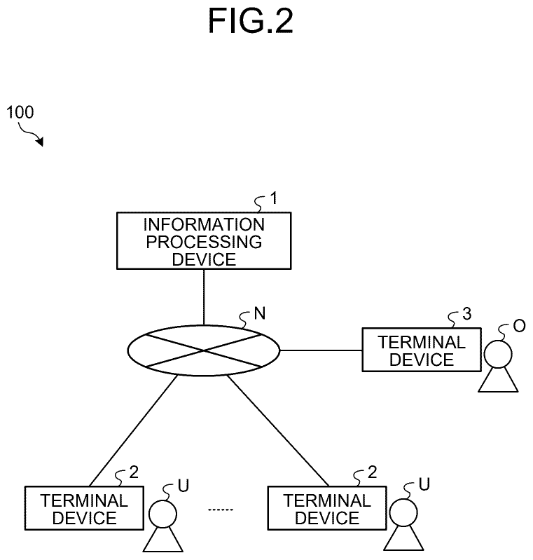

FIG. 2 is a diagram illustrating an example of the configuration of the information processing system according to the present embodiment. As illustrated in FIG. 2, an information processing system 100 according to the present embodiment includes the information processing device 1, a plurality of terminal devices 2, and a terminal device 3.

The terminal devices 2 are used by users U different from each other. The terminal device 3 is, for example, a terminal device of a business operator O that provides the secret prompts. In the example illustrated in FIG. 2, one terminal device 3 is illustrated. However, when there are a plurality of business operators O providing the secret prompts, a plurality of terminal devices 3 are included in the information processing system 100.

The terminal devices 2 and 3 are, for example, notebook PCs (personal computers), desktop PCs, smartphones, tablet PCs, and wearable devices. Wearable devices are, for example, but not limited to, smart glasses, smart watches, or the like.

The information processing device 1, the terminal devices 2, and the terminal device 3 are connected to each other in a communicable manner via a network N in a wired or wireless manner. Note that the information processing system 100 illustrated in FIG. 2 may include a plurality of information processing devices 1, and the like.

The network N includes, for example, a wide area network (WAN) such as the Internet and mobile communication networks such as Long Term Evolution (LTE), 4th Generation (4G), and 5th Generation (5G: 5th generation mobile communication system).

The terminal devices 2 and 3 can communicate with the information processing device 1 and the like by connecting to the network N via short-range wireless communication such as a mobile communication network, Bluetooth (registered trademark), and a wireless local area network (LAN).

### 3. Configuration of Information Processing Device 1

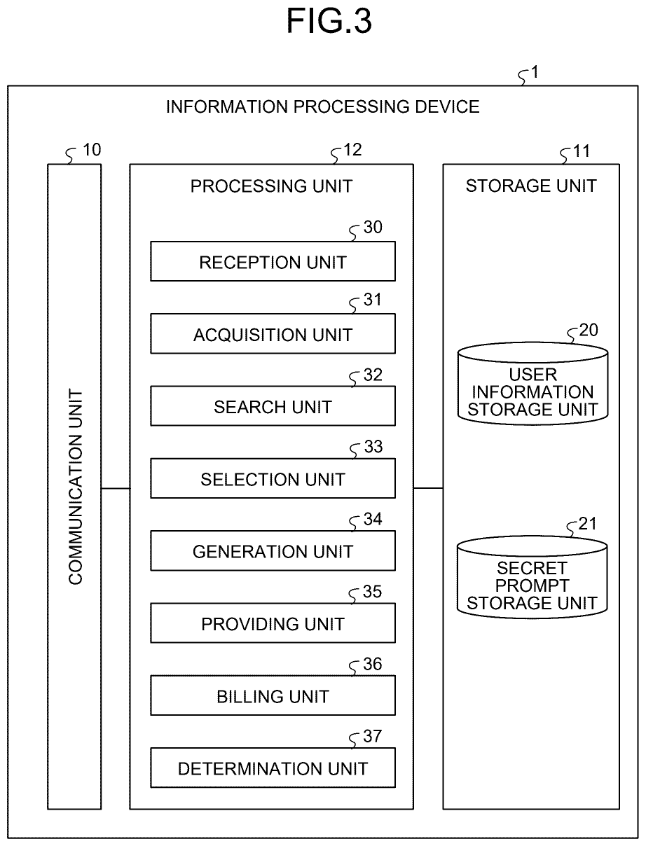

FIG. 3 is a diagram illustrating an example of the configuration of the information processing device 1 according to the present embodiment. As illustrated in FIG. 3, the information processing device 1 includes a communication unit 10, a storage unit 11, and a processing unit 12.

### 3.1. Communication Unit 10

The communication unit 10 is implemented by, for example, a communication module, a network interface card (NIC), and the like. The communication unit 10 is connected to the network N in a wired or wireless manner, and transmits and receives information to and from various other devices. For example, the communication unit 10 transmits and receives information to and from each of the terminal devices 2 and terminal device 3 via the network N.

### 3.2. Storage Unit 11

The storage unit 11 is implemented, for example, by a semiconductor memory element such as a random access memory (RAN), a flash memory, or a storage device such as a hard disk or an optical disc. The storage unit 11 includes a user information storage unit 20 and a secret prompt storage unit 21.

### 3.2.1. User Information Storage Unit 20

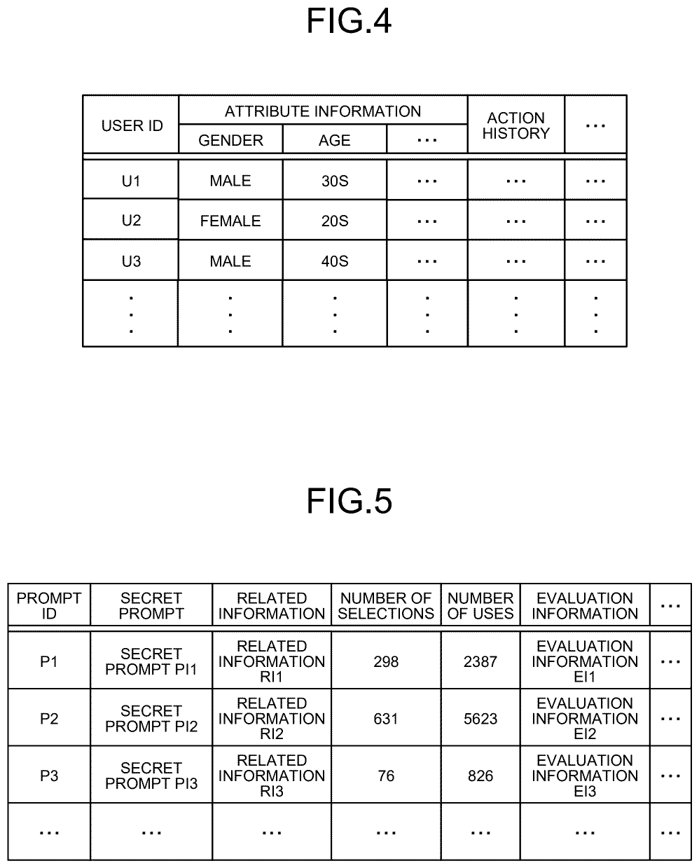

The user information storage unit 20 stores therein user information including information about the user U. FIG. 4 is a diagram illustrating an example of a user information table stored in the user information storage unit 20 of the information processing device 1 according to the present embodiment. As illustrated in FIG. 4, the user information table stored in the user information storage unit 20 includes items such as “user ID”, “attribute information”, and “action history”.

The “user ID” is identification information that identifies the user U. The “attribute information” is the attribute information of the user U corresponding to the “user ID” and includes, for example, psychographic attribute information, demographic attribute information, and the like. Demographic attributes are, for example, gender, age, place of residence, occupation, and the like, and psychographic attributes are subjects of interests, such as travel, clothing, cars, religion, as well as lifestyle, thoughts, ideological tendency, and the like.

The “action history” is the history of actions of the user U corresponding to the “user ID”. The action history of the user U includes, for example, identification information of the secret prompt selected by the processing unit 12 for the user U, identification information of the secret prompts purchased by the user U, identification information of the secret prompts used by the user U, information indicating the number of uses of each of the secret prompts used by the user U, and the like.

### 3.2.2. Secret Prompt Storage Unit 21

The secret prompt storage unit 21 stores therein various kinds of information about the secret prompts. FIG. 5 is a diagram illustrating an example of a secret prompt table stored in the secret prompt storage unit 21 of the information processing device 1 according to the present embodiment.

In the example illustrated in FIG. 5, the secret prompt table stored in the secret prompt storage unit 21 is an example of the secret prompt database described above, and includes information on items such as “prompt ID”, “secret prompt”, “related information”, “number of selections”, “number of uses”, and “evaluation information”. The “prompt ID” is an identifier that identifies the secret prompt, and it is information assigned to each of the secret prompts.

The “secret prompt” is the secret prompt associated with the “prompt ID”. The “related information” is information about the secret prompt associated with the “prompt ID” and includes, for example, identification information of the secret prompt, title of the secret prompt, heading information of the secret prompt, vector information of the heading information of the secret prompt, vector information of the secret prompt, information indicating the secret prompt, information indicating the charge amount for the secret prompt, and the like. The charge amount for the secret prompt is the fee paid by the user U for the use of the secret prompt.

The “number of selections” is information indicating the number of selections, which is the number of times the secret prompt associated with the “prompt ID” is selected and linked to the user U. The “number of uses” is the number of times the secret prompt associated with the “prompt ID” is used by the user U.

The “evaluation information” is information indicating the evaluations made by each of the users U on the provided information generated by the processing unit 12 by using the secret prompt associated with the “prompt ID”. The evaluation of the provided information is on a scale of 10, for example, but may also be on a scale of 9 or lower, or a scale of 11 or higher. The information indicating the evaluation may also be information of character strings such as reviews or comments.

Although not illustrated in the drawing, the secret prompt table also includes information such as the number of purchases, which is the number of times the secret prompt associated with the “prompt ID” is purchased by the user U.

### 3.3. Processing Unit 12

The processing unit 12 is a controller, which is implemented by, for example, a processor such as a central processing unit (CPU) or a micro processing unit (MPU) that executes various computer programs stored in a storage device inside the information processing device 1 (corresponding to an example of an information processing program) using a RAM or the like as a work area.

Furthermore, the processing unit 12 is a controller, which may be implemented by an integrated circuit such as an application specific integrated circuit (ASIC), a field programmable gate array (FPGA), or a general purpose graphic processing unit (GPGPU).

As illustrated in FIG. 3, the processing unit 12 includes a reception unit 30, an acquisition unit 31, a search unit 32, a selection unit 33, a generation unit 34, a providing unit 35, a billing unit 36, and a determination unit 37, and implements or executes the functional features and effects of the information processing described below. Note that the internal configuration of the processing unit 12 is not limited to the configuration illustrated in FIG. 3, and may be any other configuration as long as it is configured to perform the information processing described below.

### 3.3.1. Reception Unit 30

The reception unit 30 receives various kinds of information and requests. For example, the reception unit 30 receives a prompt list request from the user U. The reception unit 30 receives a prompt list request from the user U by receiving the prompt list request transmitted from the terminal device 2 of the user U, for example.

The reception unit 30 also receives search requests from the user U. The reception unit 30 receives a search request from the user U by receiving the search request transmitted from the terminal device 2 of the user U, for example.

The search request contains user-related information that includes user setting information, which is information set by the user U, and user information, which is the information about the user U who is to be the user of the secret prompt. The user U to be the user of the secret prompt is not limited to the user U of the terminal device 2 that has sent the search request, and may be any user U other than the user U of the terminal device 2 that has sent the search request. This allows the user U of the terminal device 2 to provide the secret prompt for other users U.

The user setting information is, for example, information of a character string “prompt enabling . . . ”, information of a character string “prompt for doing . . . ”, or the like. Note that “ . . . ” is a character string indicating the operation, processing, or the like that the user U desires for the generative AI to do.

For example, the user setting information may be information of a character string “prompt for summarizing the latest information on OOO”, information of a character string “prompt enabling proofreading of sentences”, information of a character string “prompt functioning as a shopping assistant”, and the like. Note that “OOO” is a specific target (for example, a person). The user setting information is not limited to the examples described above.

For example, the user setting information may be information of a character string that describes the content of the operation, processing, and the like desired by the user U in more details.

The user information includes identification information of the user U. The identification information of the user U is, for example, but not limited to, the ID of the user U or the cookie of the browser of the terminal device 2.

The generative AI is, for example, a text-generative AI, an image-generative AI, or a multimodal generative AI. The text-generative AI is, for example, a large language model trained to infer and output the next token from an input sequence of tokens. Examples thereof may be a transformer-based model or an RNN-based model, and a mixture of those models may also be used. The text-generative AI may also be a composite system combined with an identification machine and the like for preventing unauthorized use.

The transformer-based models are, for example, but not limited to, GPT, BARD, and the like. The RNN-based models are, for example, but not limited to, RWKV, and the like.

The image-generative AI is AI that generates images from texts. Although not limited thereto, examples thereof are StackGAN, AttnGAN, T2I with Transformers, Diffusion models, and the like. Examples of the Diffusion models may be DALL-E, Stable-Diffusion, and the like.

The multimodal generative AI is, for example, generative AI that generates at least one of text, image, and audio from at least one of text, image, and audio. The multimodal generative AI is, for example, but not limited to, GPT-4V, CM3Leon, and the like.

Note that it is desirable for the generative AI to be trained such that the generated results do not contain personal information and the like. The generative AI is installed in an external information processing device, and the information processing device 1 uses the generative AI via API. However, the generative AI may also be installed within the information processing device 1.

Furthermore, the reception unit 30 also receives selection requests from the user U. The reception unit 30 receives a selection request from the user U by receiving the selection request transmitted from the terminal device 2 of the user U, for example.

The selection request contains, for example, specification information that is information specifying one or more secret prompts designated by the user U from among two or more secret prompts searched by the search unit 32. Furthermore, when additional information as supplementary information is required for using the secret prompt designated by the user U, the selection request contains the additional information.

The additional information is an additional prompt when the generative AI is a text-generative AI, and it is at least one of an additional prompt and additional image data when the generative AI is a multimodal generative AI.

For example, when the secret prompt designated by the user U is a prompt that requires additional information, the user U can input the additional information into the terminal device 2 by operating the terminal device 2. Thereby, a selection request including information specifying one or more secret prompts designated by the user U and the additional information is transmitted from the terminal device 2 to the information processing device 1.

The reception unit 30 also receives tentative selection requests from the user U. The reception unit 30 receives a tentative selection request from the user U by receiving the tentative selection request transmitted from the terminal device 2 of the user U, for example. The tentative selection request contains information indicating two or more selection prompt candidates that are two or more secret prompts designated by the user U as the selection candidates.

Furthermore, when additional information as supplemental information is required for using the selection prompt candidates, the tentative selection request contains additional information for each of the selection prompt candidates in addition to the specification information that is information indicating two or more selection prompt candidates.

The reception unit 30 also receives purchase requests from the user U. The reception unit 30 receives a purchase request from the user U by receiving the purchase request transmitted from the terminal device 2 of the user U, for example. The purchase request contains information indicating one or more secret prompts selected by the user U s a purchase target.

Upon receiving the purchase request from the user U, the reception unit 30 causes the user information storage unit 20 to store therein identification information of the secret prompt specified in the purchase request as the identification information of a purchase prompt, and updates the user information table.

The reception unit 30 also receives use requests from the user U. The reception unit 30 receives a use request from the user U by receiving the use request transmitted from the terminal device 2 of the user U, for example. The reception unit 30 receives the use request from the user U, when the secret prompt specified in the use request from the user U is a purchase prompt of the user U, for example.

The use request contains information indicating one or more secret prompts selected by the user U as the use target. Furthermore, when additional information as supplemental information is required for using the secret prompt selected by the user U as the use target, the use request contains additional information for each of the secret prompts in addition to the specification information that is information indicating one or more secret prompts.

The reception unit 30 also receives evaluation information that is information indicating the evaluation of the provided information made by the user U. The reception unit 30 receives evaluation information by receiving the evaluation information transmitted from the terminal device 2 of the user U, for example.

### 3.3.2. Acquisition Unit 31

The acquisition unit 31 acquires various kinds of information from external devices and the like via the network N and the communication unit 10, and acquires various kinds of information from the storage unit 11.

For example, when a search request is received by the reception unit 30, the acquisition unit 31 acquires user-related information included in the search request received by the reception unit 30. The user-related information contains user setting information that is information set by the user U, and user information that is the information about the user U who is to be the user of the secret prompt. For example, when a selection request is received by the reception unit 30, the acquisition unit 31 acquires specification information and additional information included in the selection request received by the reception unit 30.

Furthermore, when a tentative selection request is received by the reception unit 30, for example, the acquisition unit 31 acquires specification information and additional information included in the tentative selection request received by the reception unit 30.

For example, when a purchase request is received by the reception unit 30, the acquisition unit 31 acquires specification information included in the purchase request received by the reception unit 30. Furthermore, when a use request is received by the reception unit 30, for example, the acquisition unit 31 acquires specification information and additional information included in the use request received by the reception unit 30.

### 3.3.3. Search Unit 32

The search unit 32 searches for two or more secret prompts corresponding to a search request received by the reception unit 30. For example, the search unit 32 searches for two or more secret prompts by using descriptions that describe the functional features of each of the secret prompts.

Each of the secret prompts is a prompt whose details are kept secret from the user U, and the user U is not able to grasp the detailed content of the secret prompt. Each of the secret prompts is, for example, a prompt provided by a prompt provider that is a business operator or administrator different from the provider of the generative AI described above (for example, the administrator of the information processing device 1). Note that the secret prompt may be a prompt that is provided by the user U as a prompt provider.

The secret prompt contains, for example, but not limited to, part of or all of the information of character strings indicating a definition of a task to be executed by the generative AI, a constraint condition of a task to be performed by the generative AI, a definition of the behavior and tone of the generative AI, an output format of the generative AI, and the like.

For example, when using API provided by OpenAI, the secret prompt contains information of the character string included in the input information that is input to the generative AI in association with the information indicating the role. The role is the system, user, or the like. The secret prompt is a prompt that contains at least one out of a system message whose role is system and a user message whose role is a user.

The system message is a prompt indicating the role of the generative AI, for example, and a user message is a prompt indicating a message of the user as the role, for example. The system message includes information of character strings indicating a definition of a task to be executed by the generative AI, a constraint condition of a task to be performed by the generative AI, a definition of the behavior and tone of the generative AI, an output format of the generative AI, action examples of the generative AI, and the like, for example. However, the system message is not limited thereto, and may include part of such information.

The system message may also be a message indicating a scenario, for example. In that case, for example, the system message may further contain information of a character string indicating a task end condition in the generative AI described above.

The user message may include information of character strings indicating a definition of a task to be executed by the generative AI, a constraint condition of a task to be performed by the generative AI, a definition of the behavior and tone of the generative AI, an output format of the generative AI, action examples of the generative AI, and the like, and may include part of such information.

Furthermore, when API provided by OpenAI is used, the secret prompt may further include an assistant message whose role is an assistant. The assistant message is an output message by the generative AI or a message that is treated as an output message.

The search unit 32 selects a secret prompt corresponding to the search request by searching and acquiring the secret prompt corresponding to the search request from the secret prompt table stored in the secret prompt storage unit 21.

As described above, the secret prompt table contains, for each of the secret prompts, information of the secret prompt including, for example, identification information of the secret prompt, title of the secret prompt, heading information of the secret prompt, vector information of the heading information of the secret prompt, information indicating the secret prompt, and the like. Such a secret prompt table contains secret prompts in accordance with search queries in a searchable manner.

The heading information of a secret prompt is information that indicates a description for describing functional features of the secret prompt (for example, an overview of the functional features, and the like), and vectorization of the heading information of the secret prompt is performed by embedding using a sentence embedding model (for example, a transformer-based model), for example. The vector information of the heading information of the secret prompt is represented by, for example, but not limited to, vectors of hundreds of dimensions.

Embedding using a sentence embedding model is, for example, but not limited to, embedding using text-embedding-ada provided by OpenAI, BERT, and the like.

Note that vectorization of the heading information of the secret prompt is not limited to embedding using the sentence embedding model. For example, vectorization of the secret prompt may be performed using Doc2Vec, the average of word embedding, and the like. For example, Word2Vec, fastText, and the like are used for word embedding.

The search unit 32 vectorizes the user setting information included in a search request by the same method used when vectorizing the heading information of the secret prompt. Then, the search unit 32 acquires the secret prompts corresponding to the heading information whose similarity of vectors with the user setting information is equal to or higher than a threshold or the top m-pieces (m is 2 or higher) of secret prompts corresponding to the heading information in descending order of the similarity from the secret prompt table as a search result.

Instead of the vector information of the heading information of the secret prompts, the secret prompt table may contain information of each of a plurality of keywords included in the secret prompts or the heading information thereof. In this case, for example, the search unit 32 acquires a secret prompt that contains one or more terms included in the user setting information in the search request or a secret prompt corresponding to the heading information from the secret prompt table as a search result.

Furthermore, instead of the vector information of the heading information of the secret prompt, the secret prompt table may also contain the vector information of the secret prompt. In this case, for example, the search unit 32 acquires the secret prompts whose similarity of vectors with the user setting information included in the search request is equal to or higher than a threshold or the top m-pieces (m is 2 or higher) of secret prompts in descending order of the similarity from the secret prompt table as a search result.

### 3.3.4. Selection Unit 33

The selection unit 33 selects a secret prompt corresponding to the request from the user U from among a plurality of secret prompts that are a plurality of prompts whose details are kept secret from the user U. For example, the selection unit 33 receives the secret prompt designated by the user U as the secret prompt corresponding to the request of the user U.

For example, when a selection request containing information for specifying one or more secret prompts designated by the user U is received by the reception unit 30, the selection unit 33 selects one or more secret prompts specified by the selection request from among a plurality of secret prompts. The one or more secret prompts specified in the selection request are the one or more secret prompts designated by the user U. The selection unit 33 stores the identification information of one or more selected secret prompts in the storage unit 11.

In this case, the selection request contains, for example, information for specifying one or more secret prompts designated by the user U from among the secret prompts included in the search result displayed on the terminal device 2. The selection request may also contain information for specifying one or more secret prompts designated by the user U from among the secret prompts included in the prompt list displayed on the terminal device 2, instead of the search result.

Furthermore, when a selection request containing information for specifying one or more selection prompt candidates designated by the user U is received by the reception unit 30, the selection unit 33 selects one or more selection prompt candidates specified by the selection request from among a plurality of selection prompt candidates.

The one or more selection prompt candidates specified in the selection request are the one or more selection prompt candidates designated by the user U. The selection unit 33 stores the identification information of the one or more selected selection prompt candidates in the storage unit 11. In this case, the selection request contains, for example, information for specifying one or more selection prompt candidates and the like designated by the user U from among the selection prompt candidates displayed on the terminal device 2.

Furthermore, when a tentative selection request is received by the reception unit 30, the selection unit 33 tentatively selects a plurality of secret prompts that are specified by the tentative selection request from among the secret prompts. The selection unit 33 stores the identification information of the tentatively selected secret prompts in the storage unit 11.

The selection unit 33 selects, as the secret prompt corresponding to the request of the user U, the secret prompt designated by the user U from among the secret prompts that are tentatively selected based on the information for selection generated by the generation unit 34 based on the tentatively selected secret prompts.

Furthermore, when a use request is received by the reception unit 30, the selection unit 33 selects one or more secret prompts that are specified by the use request from among the secret prompts.

### 3.3.5. Generation Unit 34

The generation unit 34 inputs the information including the selection prompt that is the secret prompt selected by the selection unit 33 to the generative AI, and causes the generative AI to generate generation information that is the information corresponding to the selection prompt that is the secret prompt selected by the selection unit 33.

For example, it is assumed that the selection prompt is a prompt that does not require additional information. In this case, the generation unit 34 inputs the information including the selection prompt to the generative AI, and causes the generative AI to generate the generation information that is the information corresponding to the selection prompt.

A selection prompt that does not require additional information is, for example, a prompt that gives an instruction to collect information on a specific target (for example, a specific disaster, a specific person, a specific object) whose status changes and to generate current information and summary information on the specific target.

In this case, for example, the generation unit 34 collects, according to the selection prompt, information on a specific target (for example, a specific disaster, a specific person, a specific object) whose status changes, inputs, as input information, information containing the collected information and instruction information indicating an instruction to execute specific processing for the collected information, and causes the generative AI to generate the generation information that is the information corresponding to the selection prompt. The specific processing includes, for example, but not limited to, processing for organizing the collected information in a specific format, processing for summarizing the collected information, and the like.

A selection prompt that does not require additional information is, for example, a prompt that contains information of a character string that gives an instruction to perform specific processing that repeats processing for outputting a character string according to a condition determined in advance or repeats processing for outputting an image according to a condition determined in advance.

Furthermore, it is assumed that the selection prompt is a prompt that requires additional information. In this case, the generation unit 34 inputs the information including information that contains the selection prompt and additional information included in the selection request to the generative AI, and causes the generative AI to generate the generation information that is the information corresponding to the selection prompt and the additional information.

A selection prompt that requires additional information is, for example, a prompt that gives an instruction to execute a specific task for the additional information. A specific task may be, for example, but not limited to, summarizing additional information, analyzing additional information (for example, sentiment analysis or the like), translating additional information, improving or proofreading additional information, generating an article or a story about additional information, and the like.

A selection prompt that requires additional information may also be a prompt for executing a specific task with the user U in a chat format, for example. In this case, the specific task is a task to perform Question and Answer (Q&A) on a specific category (for example, economy, education, or the like) in a chat format, which is a task that has the user U input information indicating a question sentence as additional information and causes the generative AI to generate information indicating an answer sentence for the question sentence.

A specific task may also be a task that has the user U sequentially input the necessary information for the user U to create information on a specific target (for example, various application forms, a novel, a cooking recipe, a blog, or the like) as additional information, and causes the generative AI to generate the information on the specific target based on such additional information.

The secret prompt selected as the selection prompt may be a prompt that includes intention definition information for extracting the intention type and the intention content. Intention definition information includes, for example, instruction information containing an instruction to extract the intention type and the intention content from the user input information, and definition information containing the information that defines the intention type and the intention content. When using API provided by OpenAI, for example, the generation unit 34 can cause the generative AI to generate intention information by using the functional feature of function calling.

The intention type is, for example, the type of intention of the additional information, and the information indicating the intention type is, for example, information specifying the function or the functional feature corresponding to the intention type. Furthermore, the intention content is the content of intention of the additional information, and the information indicating the intention content is, for example, information indicating the function argument or the parameter of the functional feature corresponding to the intention type.

In this case, intention information containing the information indicating the intention type and the information indicating the intention content is generated by the generative AI. The generation unit 34 can cause the generative AI to generate the generation information by acquiring information from an external information processing device, an internal storage unit, or the like using the intention information generated by the generative AI and inputting, to the generative AI, information containing the acquired information and instruction information indicating an instruction to generate the generation information using the acquired information.

Furthermore, when the selection prompt includes a message indicating a scenario, the generation unit 34 can repeat the processing for acquiring output by inputting information into the generative AI according to the scenario until the task end condition is satisfied, and generate the generation information based on the result of such processing. In this case, the generation unit 34 includes, in the input information to be input to the generative AI, an input/output record that contains information that is input to the generative AI in the past and information that is output by the generative AI in the past during execution of the tasks.

For example, the generation unit 34 can cause the generative AI to generate generation information by inputting the information containing the input/output record to the generative AI as the input information while changing the content to be generated by the generative AI according to the scenario, until the task end condition is satisfied.

The information input into the generative AI according to the scenario is information collected from the external information processing device, the internal storage unit, or the like, or additional information input by the user U. For example, the generation unit 34 collects information from the external information processing device, the internal storage unit, or the like according to the scenario until the task end condition is satisfied, and causes the generative AI to generate the generation information based on the collected information.

The generation unit 34 can also have the user U input the additional information according to the scenario until the task end condition is satisfied, and cause the generative AI to generate the generation information based on such additional information.

When a plurality of secret prompts are selected by the selection unit 33, the generation unit 34 causes the generative AI to generate the generation information for each of the secret prompts selected by the selection unit 33. This allows the generation unit 34 to acquire the generation information for each of the selection prompts.

Furthermore, the generation unit 34 inputs the information including the selection prompt candidates that are the prompts tentatively selected by the selection unit 33 to the generative AI, and causes the generative AI to generate, for each of the selection prompt candidates, candidate generation information that is the information corresponding to the selection prompt candidates that are the prompts tentatively selected by the selection unit 33. The generation method of the candidate generation information is the same as the generation method of the generation information described above.

### 3.3.6. Providing Unit 35

The providing unit 35 provides various kinds of information to the user U. For example, the providing unit 35 provides various kinds of information to the user U by transmitting various kinds of information to the terminal device 2 via the communication unit 10 and the network N.

When a prompt list request is received by the reception unit 30, for example, the providing unit 35 provides information of the prompt list to the user U by transmitting, to the terminal device 2, information of the prompt list in which each of the secret prompts is listed in an individually selectable manner.

Furthermore, the providing unit 35 provides each of the two or more secret prompts searched by the search unit 32 to the user U in a selectable manner. For example, the providing unit 35 provides the user U with the information of the two or more secret prompts searched by the search unit 32 by transmitting the information of the two or more secret prompts searched by the search unit 32 to the terminal device 2.

The terminal device 2 displays the information of the two or more secret prompts transmitted from the providing unit 35. The information of the secret prompts displayed on the terminal device 2 includes the titles of the secret prompts and the heading information of the secret prompts, but does not include the content itself of the secret prompts. Therefore, the information processing device 1 can provide the information of the secret prompts while keeping the detailed content of the secret prompts. The user U checks the titles and heading information of the two or more secret prompts, and operates the terminal device 2 to select one or more secret prompts from the two or more secret prompts displayed on the terminal device 2.

The information of the secret prompts displayed on the terminal device 2 may also contain information indicating the charge amount for the secret prompts, information indicating the number of selections of the secret prompts, information indicating evaluations of the secret prompts, and the like. In this case, the user U can select one or more secret prompts from the two or more secret prompts displayed on the terminal device 2 by checking the information indicating the charge amount for the secret prompts, the information indicating the number of selections of the secret prompts, the information indicating evaluations of the secret prompts, and the like.

Furthermore, the providing unit 35 provides the user U with the generation information generated by the generation unit 34 or information based on the generation information by transmitting the generation information generated by the generation unit 34 or the information based on the generation information to the terminal device 2 as the provided information. This makes it possible to provide the user U with, as the provided information, the generation information generated by using the secret prompt while concealing the detailed content of the secret prompt or the information based on the generation information.

When the information generated by the generation unit 34 using the generative AI as the generation information is the intention information, the providing unit 35 can use such intention information to acquire information from the external information processing device, the storage unit 11, or the like, and generate the provided information based on the acquired information.

Furthermore, when the generation information for each of the selection prompts is generated by the generation unit, the providing unit 35 provides the user U with the provided information for each of the selection prompts. In this case, the terminal device 2 displays the provided information for each of the selection prompts, and the user U can compare the provided information for each of the selection prompts.

The user U can check the provided information displayed on the terminal device 2, operate the terminal device 2, and input the information indicating the evaluations of the provided information.

Furthermore, when the candidate generation information for each of the selection prompt candidates is generated by the processing performed by the generation unit 34 using the generative AI, the providing unit 35 provides the user U with the information for selection containing the candidate provided information for each of the selection prompt candidates. For example, the providing unit 35 provides the information for selection to the user U by transmitting the information for selection to the terminal device 2.

The information for selection contains the candidate generation information or the candidate provided information that is the information based on the candidate generation information for each of the selection prompt candidates while being associated with the information of the selection prompt candidate (for example, information indicating the title of the selection prompt candidate or heading information). The candidate provided information is the same information as the provided information described above. However, candidate provided information may also be part of the provided information.

In this case, the terminal device 2 displays the information for selection including the candidate provided information for each of the selection prompt candidates. This allows the user U to compare the candidate provided information for each of the selection prompt candidates, and designate and use a more appropriate secret prompt.

The user U checks the candidate provided information corresponding to each of the selection prompt candidates included in the information for selection displayed on the terminal device 2, and designates one or more selection prompt candidates by operating the terminal device 2. In this case, the terminal device 2 transmits a selection request containing information for specifying one or more selection prompt candidates designated by the user U to the information processing device 1.

### 3.3.7. Billing Unit 36

The billing unit 36 performs billing processing for the user U to whom the provided information is provided by the providing unit 35. The billing processing is, for example, the processing of payment by the user U for the charge amount linked to the secret prompt that is used to generate the provided information provided to the user U at step S7.

The billing unit 36 can perform billing processing, for example, by transmitting billing information that includes information indicating the charge amount and information specifying the user U to a device of a financial institution, or by transmitting billing information that includes information indicating the charge amount and information specifying the credit card number of the user U to a device of a credit card company.

The user U can also pay the fee for the secret prompt with points instead of or in addition to a specific currency. For example, the billing unit 36 can also perform the billing processing by transmitting billing information that includes information indicating the number of points corresponding to the charge amount and information specifying the user U to a device of a point management company.

Note that points are, for example, but not limited to, rewards given to the user U by a point management company or the like, when the user U makes purchases with credit cards or cash, or when the user U subscribes to specific services.

The billing unit 36 can perform billing processing for the user U to whom the provided information is provided by the providing unit 35 with the charge amounts different for the use and purchase of the secret prompt. For example, in the case of the purchase of a secret prompt, the billing processing is performed by means of a lump-sum or monthly charge amount Ca for the provided information that is provided using the secret prompt. Meanwhile, in the case of the use of a secret prompt not purchased by the user U, the billing processing is performed by per-use charge amount Cb (<Ca) for the provided information that is provided using the secret prompt.

### 3.3.8. Determination Unit 37

The determination unit 37 determines the charge amount for the use of the secret prompt. For example, the determination unit 37 determines the charge amount based on the evaluation information that is the information indicating the evaluations of the provided information made by each of the users U. The determination unit 37 determines a higher charge amount for the secret prompt with a higher average value of the evaluations of the provided information made by each of the users U.

The determination unit 37 can determine the charge amount based on the evaluations of the provided information made by each of the users U on the basis of a reference amount set by the provider of the secret prompt. For example, the determination unit 37 determines a lower charge amount than the reference amount for the secret prompt that has a lower average value of the evaluations of the provided information made by each of the users U than a reference value. The reference value is 5 when the evaluation is on a scale of 10.

The determination unit 37 can also determine the charge amount based on the number of uses of the secret prompt by the user U. For example, the determination unit 37 determines a higher charge amount for the secret prompt with a larger number of the uses by the user U.

The determination unit 37 can also determine the charge amount based on the evaluations of the provided information made by each of the users U and the number of uses of the secret prompt used by the user U. For example, the determination unit 37 determines a higher charge amount for the secret prompt with a higher score that is acquired by applying weighted addition on the average value of the evaluations of the provided information made by each of the users U and the number of uses of the secret prompt used by the user U.

The determination unit 37 can also determine the charge amount based on the number of purchases of the secret prompt. For example, the determination unit 37 determines a higher charge amount for the secret prompt with a larger number of the purchases by the user U.

The determination unit 37 can also determine the charge amount based on the evaluations of the provided information made by each of the users U and the number of purchases of the secret prompt. For example, the determination unit 37 determines a higher charge amount for the secret prompt with a higher score that is acquired by applying weighted addition on the average value of the evaluations of the provided information made by each of the users U and the number of purchases of the secret prompt.

The determination unit 37 can also determine the charge amount based on the evaluations of the provided information made by each of the users U, the number of uses of the secret prompt, and the number of purchases of the secret prompt. For example, the determination unit 37 determines a higher charge amount for the secret prompt with a higher score that is acquired by applying weighted addition on the average value of the evaluations of the provided information made by each of the users U, the number of uses of the secret prompt, and the number of purchases of the secret prompt.

### 4. Processing Procedure

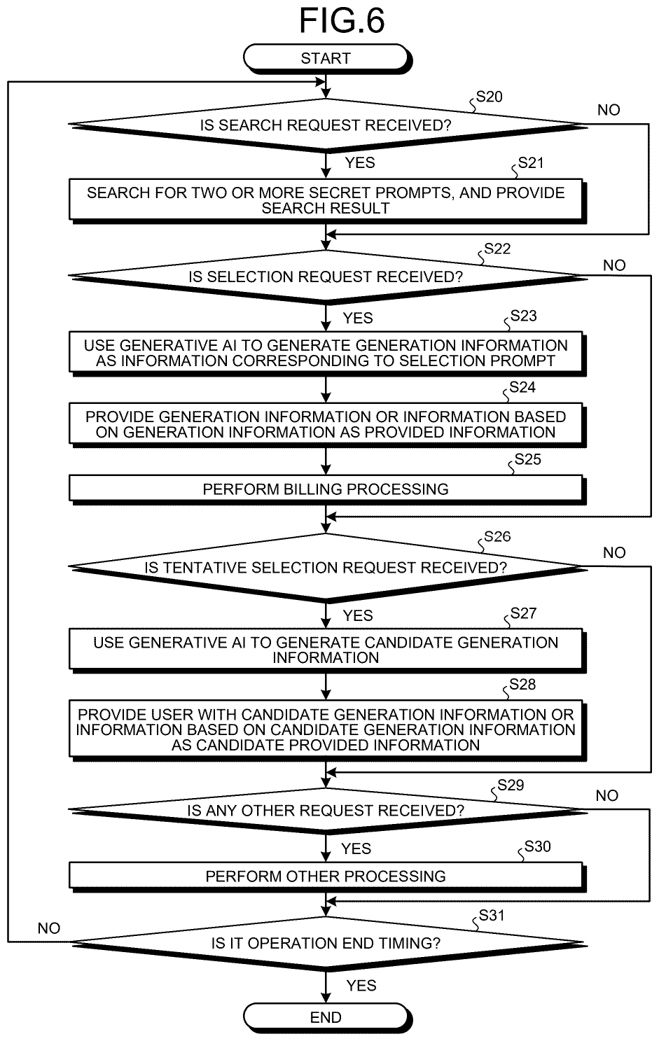

Next, the procedure of information processing performed by the processing unit 12 of the information processing device 1 according to the present embodiment will be described. FIG. 6 is a flowchart illustrating an example of the information processing performed by the processing unit 12 of the information processing device 1 according to the present embodiment.

As illustrated in FIG. 6, the processing unit 12 of the information processing device 1 determines whether a search request is received (step S20). When determined that a search request is received (Yes at step S20), the processing unit 12 searches for two or more secret prompts and provides the search result to the user U (step S21).

When processing at step S21 is completed, or when determined that no search request is received (No at step S20), the processing unit 12 determines whether a selection request is received (step S22). When determined that a selection request is received (Yes at step S22), the processing unit 12 selects the secret prompt specified by the selection request as the selection prompt, and generates generation information that is the information corresponding to the selection prompt by using the generative AI (step S23).

Then, the processing unit 12 provides the generation information or the information based on the generation information to the user U as the provided information (step S24). Thereafter, the processing unit 12 performs the billing processing for the user U to whom the provided information is provided (step S25).

When the processing at step S25 is completed, or when determined that no selection request is received (No at step S22), the processing unit 12 determines whether a tentative selection request is received (step S26). When determined that a tentative selection request is received (Yes at step S26), the processing unit 12 generates candidate generation information by using the generative AI (step S27). Then, the processing unit 12 provides the candidate generation information or the information based on the candidate generation information to the user U as the candidate provided information (step S28).

When the processing at step S28 is completed, or when determined that no tentative selection request is received (No at step S26), the processing unit 12 determines whether any other request is received (step S29). When determined that any other request is received (Yes at step S29), the processing unit 12 performs other processing (step S30).

When the processing at step S30 is completed, or when determined that no other request is received (No at step S29), the processing unit 12 determines whether it is an operation end timing (step S31). For example, in the case where the power of the information processing device 1 is turned off or the like, the processing unit 12 determines that it is the operation end timing.

The processing unit 12 shifts the processing to step S20 when determined that it is not the operation end timing (No at step S31), and ends the processing indicated in FIG. 6 when determined that it is the operation end timing (Yes at step S31).

### 5. Modification Example

In the example described above, the user setting information included in the search request contains information of character strings indicating the operation, processing, and the like that the user U desires for the generative AI to do. However, instead of or in addition to such information, the user setting information may also contain information indicating the results that the user U desires for the generative AI to provide.

In this case, the secret prompt table may further include, as the information of the secret prompts, the generation information or provided information acquired from the secret prompts using the generative AI and the vector information thereof. In this case, the search unit 32 acquires the secret prompts whose similarity of vectors with the user setting information is equal to or higher than a threshold or the top m-pieces (m is 2 or higher) of secret prompts corresponding to the generation information or provided information in descending order of the similarity from the secret prompt table as a search result.

The search unit 32 can also calculate a score acquired by applying weighted addition on the similarity of vectors between the user setting information and the heading information and the similarity of vectors between the user setting information and the generation information or the provided information, and acquire, from the secret prompt table as a search result, the secret prompts whose scores are equal to or higher than a threshold or the top m-pieces (m is 2 or higher) of secret prompts corresponding to combinations of the heading information and the generation information or the provided information in descending order of the similarity.

The search unit 32 can also search for two or more secret prompts from the secret prompt table based on the attribute information, which is information indicating the attributes of the user U of the terminal device 2 that has sent the search request, and the user setting information. Attributes of the user U are, for example, demographic attributes, psychographic attributes, and the like of the user U.

For example, the search unit 32 can provide, to the user U as a search result, the secret prompt for which the average value of the evaluations made by other users U having the same or similar attributes as those of the user U of the terminal device 2 that has sent the search request is higher than a threshold or the top m-pieces (m is 1 or higher) of such secret prompts among a plurality of secret prompts corresponding to the user setting information.

Furthermore, the search unit 32 can provide, to the user U as a search result, the secret prompt for which the number of uses by other users U having the same or similar attributes as those of the user U of the terminal device 2 that has sent the search request is higher than a threshold or the top m-pieces (m is 1 or higher) of such secret prompts among a plurality of secret prompts corresponding to the user setting information.

Furthermore, when the secret prompt is a prompt that uses the generative AI in a chat format, the determination unit 37 can also determine the charge amount for the use of such secret prompt based on the input/output record performed in the chat format.

For example, the determination unit 37 can determine a higher charge amount for the use of the secret prompt having a greater or smaller number of times of input/output, or determine a higher charge amount for the use of the secret prompt having a greater or smaller number of tokens input to the generative AI as character strings.

The determination unit 37 can also input, to the generative AI as input information, the information containing the input/output record and instruction information that is information of a character string indicating an instruction to determine the accuracy and value of the secret prompt from such input/output record, and cause the generative AI to output information indicating the accuracy and value of the secret prompt. In this case, the determination unit 37 can determine a higher charge amount for the use of the secret prompt with higher accuracy and value.

Furthermore, when a maximum charge amount is set for each of the users U by a request or the like of the user U, the determination unit 37 can also search for the secret prompts for which the charge amount does not exceed the maximum amount.

### 6. Hardware Configuration

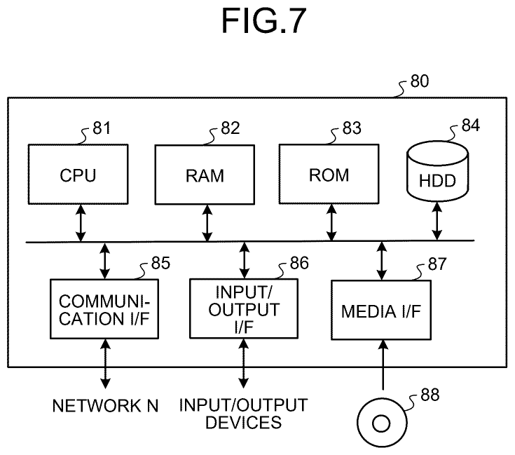

The information processing device 1 according to the present embodiment described above is implemented by a computer 80 with the configuration Illustrated in FIG. 7, for example. FIG. 7 is a hardware configuration diagram illustrating an example of the computer 80 that implements the functional features of the information processing device 1 according to the present embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates based on computer programs stored in the ROM 83 or the HDD 84 to control each of the units. The ROM 83 stores therein a boot program that is executed by the CPU 81 at the startup of the computer 80, as well as computer programs and the like dependent on the hardware of the computer 80.

The HDD 84 stores therein computer programs executed by the CPU 81 as well as data and the like used by such computer programs. The communication interface 85 receives data from other devices via the network N (see FIG. 2) and sends it to the CPU 81, and transmits data generated by the CPU 81 to other devices via the network N.

The CPU 81 controls output devices such as a display, a printer, and the like as well as input devices such as a keyboard, a mouse, and the like via the input/output interface 86. The CPU 81 acquires data from the input devices via the input/output interface 86. The CPU 81 also outputs the generated data to the output devices via the input/output interface 86.

The media interface 87 reads out the computer programs or data stored in a recording medium 88 and provides those to the CPU 81 via the RAM 82. The CPU 81 loads such computer programs onto the RAM 82 from the recording medium 88 via the media interface 87, and executes the loaded computer programs. The recording medium 88 may be, for example, an optical recording medium such as a digital versatile disc (DVD) or a phase change rewritable disk (PD), an optical magnetic recording medium such as a magneto-optical disk (MO), a tape medium, a magnetic recording medium, a semiconductor memory, or the like.

For example, when the computer 80 functions as the information processing device 1 according to the present embodiment, the CPU 81 of the computer 80 executes the computer program loaded on the RAM 82 to implement the functional features of the processing unit 12. Furthermore, the data in the storage unit 11 is stored in the HDD 84. The CPU 81 of the computer 80 reads out and executes those programs from the recording medium 88. However, as another example, those computer programs may be acquired from other devices via the network N.

### 7. Others

Among each kind of the processing described in the above embodiment, all or part of the processing described to be performed automatically may be performed manually, or all or part of the processing described to be performed manually may be performed automatically by known methods. In addition, the information including the processing procedures, specific names, and various kinds of data and parameters indicated in the specification and drawings may be changed as desired, unless otherwise noted. For example, the various kinds of information indicated in each of the drawings are not limited thereto.

Furthermore, each structural component of each device illustrated in the drawings indicates a functional concept, and does not necessarily need to be physically configured as illustrated in the drawings. In other words, the specific form of dispersion and integration of each device is not limited to that illustrated in the drawings, and all or part thereof may be functionally or physically dispersed and integrated in arbitrary units in accordance with various loads, use conditions, and the like.

For example, the information processing device 1 described above may be implemented with a terminal device and a server computer, or with a plurality of server computers. Furthermore, the configuration thereof may be flexibly changed, such as by calling an external platform or the like with API, network computing, or the like depending on the functional features.

Furthermore, the embodiment and the modification example described above can be combined as appropriate to the extent that there is no contradiction in the content of the processing.

### 8. Effects

As described above, the information processing device 1 according to the present embodiment includes the selection unit 33, the generation unit 34, and the providing unit 35. The selection unit 33 selects a prompt corresponding to a request from the user U from among a plurality of prompts whose details are kept secret from the user U. The generation unit 34 inputs information including the prompt selected by the selection unit 33 to the generative AI, and causes the generative AI to generate information corresponding to the prompt selected by the selection unit 33. The providing unit 35 provides the information generated by the generation unit 34 or information based on such generated information to the user U as the provided information. This allows the information processing device 1 to generate information using a more appropriate prompt corresponding to the request of the user U.

The information processing device 1 also includes the billing unit 36 that performs billing processing for the user U to whom the provided information is provided by the providing unit 35. This allows the information processing device 1 to facilitate the provision of prompts corresponding to the request of the user U, and generate information using a more appropriate prompt corresponding to the request of the user U.

The information processing device 1 also includes the determination unit 37 that determines the charge amount for the use of the prompt. This allows the information processing device 1 to facilitate the provision of prompts corresponding to the request of the user U.

The determination unit 37 also determines the charge amount based on the evaluation of the provided information made by the user U. This allows the information processing device 1 to facilitate the provision of more appropriate prompt corresponding to the request of the user U.

Furthermore, the generation unit 34 causes the generative AI to generate the information corresponding to each of a plurality of prompts, the providing unit 35 provides the user U with the information for selection containing the information corresponding to each of the prompts generated by the generation unit 34 or the information based on each piece of such generated information, and the selection unit 33 selects, as the prompt corresponding to the request of the user U, the prompt designated by the user U from among the prompts based on the information for selection generated by the generation unit 34. This allows the information processing device 1 to more properly generate the information using a more appropriate prompt corresponding to the request of the user U.

The information processing device 1 also includes the reception unit 30 that receives a search request from the user U, and the search unit 32 that searches for, as a plurality of prompts, two or more prompts corresponding to the search request received by the reception unit 30. The providing unit 35 provides each of the prompts searched by the search unit 32 to the user U in a selectable manner. This allows the information processing device 1 to more properly generate the information using a more appropriate prompt corresponding to the request of the user U.

Furthermore, the selection unit 33 selects the prompt designated by the user U as the prompt corresponding to the request of the user U. This allows the information processing device 1 to more properly generate the information using a more appropriate prompt corresponding to the request of the user U.

The search unit 32 also searches for a plurality of prompts by using descriptions that describe the functional features of each of the prompts. This allows the information processing device 1 to more properly generate the information using a more appropriate prompt corresponding to the request of the user U.

While the embodiment of the present application is described above in detail based on the accompanying drawings, the embodiment is presented by way of example only, and it is possible to implement the present invention in other forms by applying various changes and modifications based on the knowledge of those skilled in the art on the aspects described in the section of the disclosure of the invention.

Furthermore, “unit” described above can be read as “means” or “circuit”. For example, the acquisition unit can be read as acquisition means or an acquisition circuit.

According to one aspect of the present embodiment, it is possible to support the use of more appropriate prompts corresponding to the request of the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a selection unit that selects a prompt corresponding to a request of a user from among a plurality of prompts whose details are kept secret from the user;
a generation unit that inputs information containing the prompt selected by the selection unit into generative AI, and causes the generative AI to generate information corresponding to the prompt selected by the selection unit; and
a providing unit that provides, to the user as provided information, the information generated by the generation unit or information based on the generated information.

2. The information processing device according to claim 1, comprising a billing unit that performs billing processing for the user to whom the provided information is provided by the providing unit.

3. The information processing device according to claim 2, comprising a determination unit that determines a charge amount for use of the prompt.

4. The information processing device according to claim 3, wherein the determination unit determines the charge amount based on an evaluation of the provided information made by the user.

5. The information processing device according to claim 1, wherein
the generation unit causes the generative AI to generate information corresponding to each of the prompts;
the providing unit provides the user with information for selection containing the information corresponding to each of the prompts generated by the generation unit or containing information based on each piece of the information; and
the selection unit selects, as the prompt corresponding to the request of the user, a prompt designated by the user from among the prompts based on the information for selection generated by the generation unit.

6. The information processing device according to claim 5, comprising:
a reception unit that receives a search request from the user; and
a search unit that searches for, as the prompts, two or more prompts corresponding to the search request received by the reception unit, wherein
the providing unit provides, to the user, each of the prompts searched by the search unit in a selectable manner.

7. The information processing device according to claim 1, wherein the selection unit selects a prompt designated by the user as the prompt corresponding to the request of the user.

8. The information processing device according to claim 6,
wherein the search unit searches for the prompts by using descriptions that describe functional features of each of the prompts.

9. An information processing method executed by a computer, the information processing method comprising:
selecting a prompt corresponding to a request of a user from among a plurality of prompts whose details are kept secret from the user;
inputting information containing the prompt selected at the selecting into generative AI, and generating, using the generative AI, information corresponding to the prompt selected at the selecting; and
providing, to the user as provided information, the information generated at the generating or information based on the generated information.

10. A non-transitory computer readable storage medium having stored an information processing program that causes a computer to execute:
selecting a prompt corresponding to a request of a user from among a plurality of prompts whose details are kept secret from the user;
inputting information containing the prompt selected at the selecting into generative AI, and generating, using the generative AI, information corresponding to the prompt selected at the selecting; and
providing, to the user as provided information, the information generated at the generating or information based on the generated information.
